(19) United States
(12) Patent Application Publication
(10) Pub. No.: US 2025/0245917 A1
(43) Pub. Date: Jul. 31, 2025

(54) MULTIMODAL FREE SPACE PREDICTION BY CROSS-MODAL DEFORMABLE STIXEL PREDICTOR

(71) Applicant: QUALCOMM Incorporated, San Diego, CA (US)

(72) Inventors: Hazem Ahmed Mohamed Mohamed Rashed, Kronach (DE); Kiran Bangalore Ravi, Paris (FR); Senthil Kumar Yogamani, Headford (IE)

(21) Appl. No.: 18/428,957

(22) Filed: Jan. 31, 2024

(51) Int. Cl. G06T 17/00; G01S 17/89; G06T 7/13; G06V 10/44

(52) U.S. Cl. CPC G06T 17/00; G01S 17/89; G06T 7/13; G06V 10/44

(57) ABSTRACT

Example systems and techniques are described for controlling operation of a vehicle. An example system includes one or more memories configured to store a machine learning model and one or more processors. The one or more processors are configured to obtain two-dimensional (2D) image data and three-dimensional (3D) point cloud data. The one or more processors are configured to generate one or more multimodal fused 3D stixels based on the 2D image data and the 3D point cloud data. As part of generating the one or more multimodal fused 3D stixels, the one or more processors are configured to execute a machine learning model, the machine learning model having been trained with a 3D stixel correction. The one or more processors are configured to control operation of a vehicle based on the one or more multimodal fused 3D stixels.

### TECHNICAL FIELD

This disclosure relates to autonomous vehicles and vehicles including advanced driver-assistance systems (ADAS).

### BACKGROUND

An autonomous driving vehicle is a vehicle that is configured to sense the environment around the vehicle, such as the existence and location of other objects, and operating without human control. An autonomous driving vehicle may include a light detection and ranging (LiDAR) system and/or other sensor system for sensing point cloud data indicative of the existence and location of other objects around the autonomous driving vehicle. In some examples, such an autonomous driving vehicle may be referred to as an ego vehicle. A vehicle having an ADAS is a vehicle that includes systems which may assist a driver in operating the vehicle, such as parking or driving the vehicle.

### SUMMARY

Free space estimation is an important perception task for some applications, such as autonomous driving. Free space estimation may include detecting the drivable space around a vehicle. In an autonomous driving application, all non-drivable areas should be identified, including dynamic objects, static objects, infrastructure, curbs, and unidentified objects, for example, to avoid the vehicle colliding with such objects. Free space may be used directly as an input to path planning where only drivable space is considered for creating a potential trajectory of the vehicle so as to avoid collision with surrounding objects. Free space may be estimated using sensor data, such as LiDAR, camera, and/or other sensor data.

One technique that may be used to represent an object, when determining free space, is to use a stixel. A stixel is a superpixel representation of depth information in an image. A stixel may take the form of a vertical stick that approximates the closest obstacles within a certain vertical slice of a scene. LiDAR data may be relatively sparse which may lead to inaccurately located stixels. For example, stixels may “hang” and not contact a ground edge or plane in a scene. Such hanging stixels may lead to less than accurate estimation of free space, which may lead to an increased risk of a collision with an object in the environment.

The present disclosure generally relates to free space prediction for autonomous driving and/or assisted driving (e.g., ADAS) applications. For example, this disclosure describes techniques for the use of a cross-modal deformable stixel predictor that may accurately interpolate stixels despite sparsity of LiDAR data. Such interpolated stixels may be utilized to more accurately predict free space and to navigate or maneuver the vehicle through the predicted free space.

Current techniques for training a machine learning model, such as a deep neural network (DNN), to interpolate stixels require expensive annotations. The techniques of this disclosure do not require annotations, and instead use a three-dimensional (3D) stixel correction output from a geometric cross-modal stixel interpolation as training data for the machine learning model.

In one example, this disclosure describes a system comprising: one or more memories configured to store a machine learning model; and one or more processors communicatively coupled to the memory, the one or more processors being configured to: obtain two-dimensional (2D) image data; obtain three-dimensional (3D) point cloud data; generate one or more multimodal fused 3D stixels based on the 2D image data and the 3D point cloud data, wherein as part of generating the one or more multimodal fused 3D stixels, the one or more processors are configured to execute a machine learning model, the machine learning model having been trained with a 3D stixel correction; and control operation of a vehicle based on the one or more multimodal fused 3D stixels.

In another example, this disclosure describes a system for training a machine learning model, the system comprising: one or more memories configured store the machine learning model; and one or more processors communicatively coupled to the one or more memories, the one or more processors being configured to: project a 3D stixel on a 2D image; generate a search window based on a bottom of the 3D stixel in a 3D space; project the search window in a 2D space, the 2D space corresponding with the 2D image; determine a ground boundary inside the search window in the 2D space, based on one or more appearance features in the 2D image; determine a correction offset in the 2D space between the ground boundary and a bottom of the projected 3D stixel, the bottom of the projected 3D stixel corresponding to the bottom of the 3D stixel; project the correction offset into the 3D space; and train the machine learning model based on the projected correction offset.

In another example, this disclosure describes a method comprising: for controlling operation of a vehicle, the method comprising: obtaining two-dimensional (2D) image data; obtaining three-dimensional (3D) point cloud data; generating one or more multimodal fused 3D stixels based on the 2D image data and the 3D point cloud data, wherein generating the one or more multimodal fused 3D stixels comprises executing a machine learning model, the machine learning model having been trained with a 3D stixel correction; and controlling operation of a vehicle based on the one or more multimodal fused 3D stixels.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a block diagram illustrating an example processing system according to one to more aspects of this disclosure.

FIG. 2 is a block diagram illustrating example vehicle systems according to one or more aspects of this disclosure.

FIG. 3 is a conceptual diagram illustrating an example of 3D point cloud data and 3D stixels overlaid on 2D image data according to one or more aspects of this disclosure.

FIG. 4 is a block diagram of example stixel extraction techniques according to one or more aspects of this disclosure.

FIG. 5 is a block diagram illustrating example techniques for generating 3D stixel correction data for training a machine learning model according to one or more aspects of this disclosure.

FIG. 6 is a conceptual diagram illustrating example techniques for determining a 3D stixel correction offset according to one or more aspects of this disclosure.

FIG. 7 is a block diagram illustrating example cross-modal deformable stixel prediction techniques according to one or more aspects of this disclosure.

FIG. 8 is a block diagram illustrating an example architecture for performing cross-modal deformable stixel prediction according to one or more aspects of this disclosure.

FIG. 9 is a conceptual diagram illustrating an example cross-modal deformable convolution according to one or more aspects of this disclosure.

FIG. 10 is a flow diagram illustrating example vehicle operation techniques in accordance with one or more aspects of this disclosure.

FIG. 11 is a flow diagram illustrating machine learning model training techniques according to one or more aspects of this disclosure.

### DETAILED DESCRIPTION

An autonomous driving vehicle, such as an ego vehicle, or an assisted driving vehicle (e.g., a vehicle including an ADAS), may utilize a machine learning model for controlling operation of the vehicle. For example, the machine learning model may control or assist in controlling the acceleration, breaking, and/or navigation of the vehicle. Such operations may rely on the determination of free space of the environment surrounding the vehicle. Free space may include navigable space around the vehicle, unencumbered by obstacles.

LiDAR data may include data from a LiDAR system mounted on or in the vehicle. LiDAR operates by emitting pulses of light of which a LiDAR sensor senses a reflection. A LiDAR system may use the time between the emission of the pulse and the detection of the reflection of the pulse to determine a distance of the point at which the LiDAR pulse is reflected, for example, based on the speed of light. A collection of reflected pulses (which may be referred to as points) sensed by the LiDAR system may be referred to as a point cloud. By identifying specific objects represented within the point cloud, a vehicle may become aware of distances of such objects from the vehicle or the LiDAR system which may be useful in determining free space and controlling operations of the vehicle so as to avoid neighboring vehicles.

LiDAR data may be relatively sparse when compared to image data that may be acquired by a camera. Additionally, the sparsity of LiDAR data may change over distance as the angle between two emitted pulses may cause the pulse to diverge as the pulses travel further away from the LiDAR emitter. As such, reflection points from further away objects may be sparser than reflection points from closer objects.

Image data from a camera may be denser than LiDAR data, but may not provide much depth information. Depth information may be important in determining free space, as a vehicle may need to take immediate action to avoid an obstacle very close to the vehicle, while the vehicle may not need to take such action to avoid an obstacle far from the vehicle.

There are different techniques that may be used to represent objects when determining free space. One technique is to use bounding boxes with a single depth value for each object. Another technique is to use semantic segmentation with a depth value for each pixel, for example, of a 2D representation of a scene. A third techniques is to use stixels, with a depth value for each stixel.

The use of bounding boxes may not be desirable, as labeling a large object, such as a truck, with a single depth value may make a collision with the object more likely. The use of semantic segmentation with a depth value for every pixel may be exceedingly expensive computationally and expensive in terms of memory required. As such, it may be desirable to use stixels when performing free space determinations.

This disclosure describes techniques and systems for predicting free space with respect to irregularly sampled surfaces using a trained machine learning model, such as a cross-modal deformable stixel predictor. By using a cross-modal deformable stixel predictor, a vehicle may more accurately determine the free space in the area around the vehicle and more safely and accurately navigate through the free space, avoiding collisions with obstacles that may otherwise be considered to be free space.

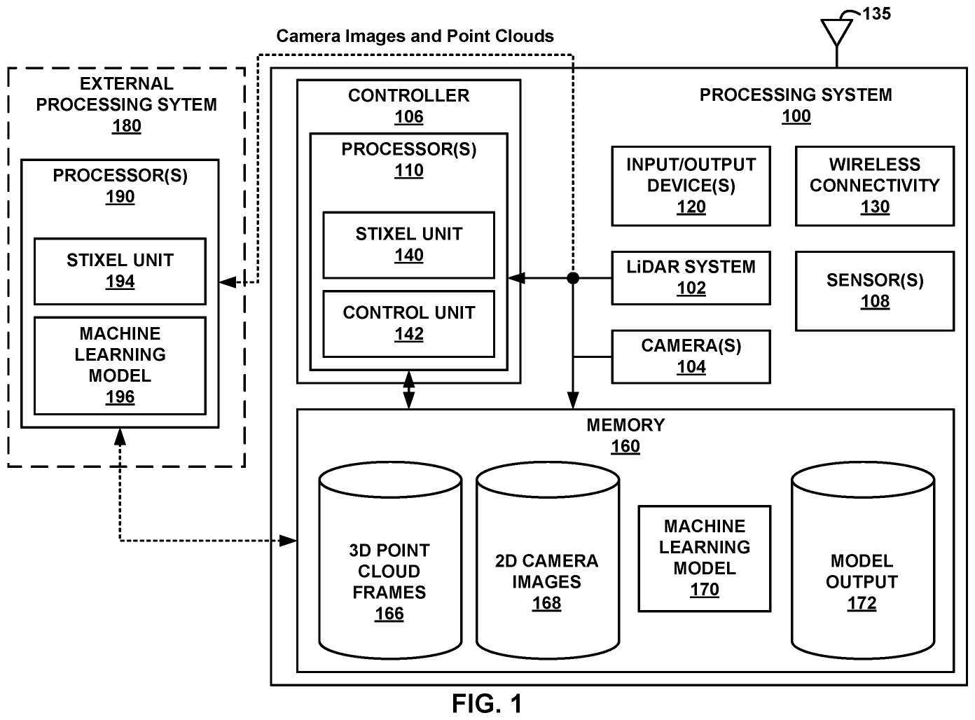

FIG. 1 is a block diagram illustrating an example processing system in accordance with one to more techniques of this disclosure. Processing system 100 may be used in a vehicle, such as an autonomous driving vehicle or an assisted driving vehicle (e.g., a vehicle having an ADAS or an “ego vehicle”). In such an example, processing system 100 may represent an ADAS. In other examples, processing system 100 may be used in robotic applications, virtual reality (VR) applications, or other kinds of applications that may include both a camera and a LiDAR system. The techniques of this disclosure are not limited to vehicular applications. The techniques of this disclosure may be applied by any system that processes image data and/or position data.

Processing system 100 may include LiDAR system 102, camera(s) 104, controller 106, one or more sensor(s) 108, input/output device(s) 120, wireless connectivity component 130, and memory 160. LiDAR system 102 may include one or more light emitters (e.g., lasers) and one or more light sensors. LiDAR system 102 may, in some cases, be deployed in or about a vehicle. For example, LiDAR system 102 may be mounted on a roof of a vehicle, in bumpers of a vehicle, and/or in other locations of a vehicle. LiDAR system 102 may be configured to emit light pulses and sense the light pulses reflected off of objects in the environment. LiDAR system 102 is not limited to being deployed in or about a vehicle. LiDAR system 102 may be deployed in or about another kind of object.

In some examples, the one or more light emitters of LiDAR system 102 may emit such pulses in a 360-degree field around the vehicle so as to detect objects within the 360-degree field by detecting reflected pulses using the one or more light sensors. For example, LiDAR system 102 may detect objects in front of, behind, or beside LiDAR system 102. While described herein as including LiDAR system 102, it should be understood that another distance or depth sensing system may be used in place of LiDAR system 102. The output of LiDAR system 102 are called point clouds or point cloud frames.

A point cloud frame output by LiDAR system 102 is a collection of 3D data points that represent the surface of objects in the environment. LiDAR processing circuitry of LiDAR system 102 may generate one or more point cloud frames based on the one or more optical signals emitted by the one or more light emitters of LiDAR system 102 and the one or more reflected optical signals sensed by the one or more light sensors of LiDAR system 102. These points are generated by measuring the time it takes for a laser pulse to travel from a light emitter to an object and back to a light detector. Each point in the cloud has at least three attributes: x, y, and z coordinates, which represent its position in a Cartesian coordinate system. Some LiDAR systems also provide additional information for each point, such as intensity, color, and classification.

Intensity (also called reflectance) is a measure of the strength of the returned laser pulse signal for each point. The value of the intensity attribute depends on various factors, such as the reflectivity of the object's surface, distance from the sensor, and the angle of incidence. Intensity values can be used for several purposes, including distinguishing different materials, and enhancing visualization: Intensity values can be used to generate a grayscale image of the point cloud, helping to highlight the structure and features in the data.

Color information in a point cloud is usually obtained from other sources, such as digital cameras mounted on the same platform as the LiDAR sensor, and then combined with the LiDAR data. Cameras used to capture color information for point cloud data may, in some examples, be separate from camera(s) 104. The color attribute includes color values (e.g., red, green, and blue (RGB)) values for each point. The color values may be used to improve visualization and aid in enhanced classification (e.g., the color information can aid in the classification of objects and features in the scene, such as vegetation, buildings, and roads). In some examples, color values may be indicative of an edge or boundary between two objects and/or features, such as between a building and a sidewalk.

Classification is the process of assigning each point in the point cloud to a category or class based on its characteristics or its relation to other points. The classification attribute may be an integer value that represents the class of each point, such as ground, vegetation, building, water, etc. Classification can be performed using various algorithms, often relying on machine learning techniques or rule-based approaches.

Camera(s) 104 may include any type of camera configured to capture video or image data in the environment around processing system 100 (e.g., around a vehicle). In some examples, processing system 100 may a single camera 104. In other examples, processing system 100 may include multiple camera(s) 104. For example, camera(s) 104 may include a front facing camera (e.g., a front bumper camera, a front windshield camera, and/or a dashcam), a back facing camera (e.g., a backup camera), side facing cameras (e.g., cameras mounted in sideview mirrors). Camera(s) 104 may be a color camera or a grayscale camera. In some examples, camera(s) 104 may be a camera system including more than one camera sensor. While techniques of this disclosure will be described with reference to a two-dimensional (2D) photographic camera and a LiDAR system, the techniques of this disclosure may be applied to the outputs of other sensors that capture information, including a sonar sensor, a radar sensor, an infrared camera, and/or a time-of-flight (ToF) camera.

LiDAR system 102 may, in some examples, be configured to collect 3D point cloud frames 166. Camera(s) 104 may, in some examples, be configured to collect 2D camera images 168. Features within 2D camera images and 3D point cloud frames may be used to predict stixels, such that respective ends of stixels (e.g., bottoms) are properly set at a ground boundary and the stixels are not “hanging.” The proper placement of stixels in a 3D environment may improve the accuracy of an estimation of free space in which to navigate a vehicle, thereby improving the collision avoidance and the safety of navigation in the estimated free space.

Wireless connectivity component 130 may include subcomponents, for example, for third generation (3G) connectivity, fourth generation (4G) connectivity (e.g., 4G Long Term Evolution (LTE)), fifth generation (5G) connectivity (e.g., 5G or New Radio (NR)), Wi-Fi connectivity, Bluetooth connectivity, and other wireless data transmission standards. Wireless connectivity component 130 is further connected to one or more antennas 135.

Processing system 100 may also include one or more input/output devices 120, such as screens, touch-sensitive surfaces (including touch-sensitive displays), physical buttons, speakers, microphones, and the like. Input/output device(s) 120 (e.g., which may include an I/O controller) may manage input and output signals for processing system 100. In some cases, input/output device(s) 120 may represent a physical connection or port to an external peripheral. In some cases, input/output device(s) 120 may utilize an operating system. In other cases, input/output device(s) 120 may represent or interact with a modem, a keyboard, a mouse, a touchscreen, or a similar device. In some cases, input/output device(s) 120 may be implemented as part of a processor (e.g., a processor of processor(s) 110). In some cases, a user may interact with a device via input/output device(s) 120 or via hardware components controlled by input/output device(s) 120.

Controller 106 may be an autonomous or assisted driving controller (e.g., an ADAS) configured to control operation of processing system 100 (e.g., including the operation of a vehicle). For example, controller 106 may control acceleration, braking, and/or navigation of vehicle through the environment surrounding vehicle. Controller 106 may include one or more processors, e.g., processor(s) 110. Controller 106 is not limited to controlling vehicles. Controller 106 may additionally or alternatively control any kind of controllable device, such as a robotic component. Processor(s) 110 may include one or more central processing units (CPUs), such as single-core or multi-core CPUs, graphics processing units (GPUs), digital signal processor (DSPs), application specific integrated circuits (ASICs), field programmable gate arrays (FPGAs), neural processing unit (NPUs), multimedia processing units, and/or the like. Instructions applied by processor(s) 110 may be loaded, for example, from memory 160 and may cause processor(s) 110 to perform the operations attributed to processor(s) in this disclosure.

An NPU is generally a specialized circuit configured for implementing control and arithmetic logic for executing machine learning algorithms, such as algorithms for processing artificial neural networks (ANNs), DNNs, random forests (RFs), kernel methods, and the like. An NPU may sometimes alternatively be referred to as a neural signal processor (NSP), a tensor processing unit (TPU), a neural network processor (NNP), an intelligence processing unit (IPU), or a vision processing unit (VPU).

Processor(s) 110 may be configured to accelerate the performance of common machine learning tasks, such as image classification, machine translation, object detection, and various other tasks. In some examples, a plurality of processor(s) 110 may be instantiated on a single chip, such as a system on a chip (SoC), while in other examples one or more of processor(s) 110 may be part of a dedicated machine learning accelerator device.

In some examples, one or more of processor(s) 110 may be optimized for training or inference, or in some cases configured to balance performance between both. For processor(s) 110 that are capable of performing both training and inference, the two tasks may still generally be performed independently.

In some examples, processor(s) 110 designed to accelerate training are generally configured to accelerate the optimization of new models, which is a highly compute-intensive operation that involves inputting an existing dataset (often labeled or tagged), iterating over the dataset, and then model parameters, such as weights and biases, in order to improve model performance. Generally, optimizing based on a wrong prediction involves propagating back through the layers of the model and determining gradients to reduce the prediction error. In some examples, some or all of the adjustment of model parameters may be performed outside of processing system 100, such as in external processing system 180.

In some examples, processor(s) 110 designed to accelerate inference are generally configured to operate on complete models. Such processor(s) 110 may thus be configured to input a new piece of data and rapidly process the data through an already trained model to generate a model output 172 (e.g., an inference).

In some examples, processor(s) 110 may operate on predictive models such as artificial neural networks (ANNs) or random forests (RFs). An ANN may include a hardware and/or a software component that includes a number of connected nodes (e.g., artificial neurons), which loosely correspond to the neurons in a human brain. Each connection, or edge, transmits a signal from one node to another (like the physical synapses in a brain). When a node receives a signal, it processes the signal and then transmits the processed signal to other connected nodes. In some cases, the signals between nodes comprise real numbers, and the output of each node is computed by a function of the sum of its inputs. Each node and edge may be associated with one or more node weights that determine how the signal is processed and transmitted. During the training process, these weights are adjusted to improve the accuracy of the result (i.e., by minimizing a loss function which corresponds in some way to the difference between the current result and the target result). The weight of an edge increases or decreases the strength of the signal transmitted between nodes. In some cases, nodes have a threshold below which a signal is not transmitted at all. In some examples, the nodes are aggregated into layers. Different layers perform different transformations on their inputs. The initial layer is known as the input layer and the last layer is known as the output layer. In some cases, signals traverse certain layers multiple times.

A DNN is a class of neural network that is commonly used in computer vision or image classification systems. A DNN may include the use of multiple layers. One type of DNN may be a convolutional neural network (CNN). In some cases, a CNN may enable processing of digital images with minimal pre-processing. A CNN may be characterized by the use of convolutional (or cross-correlational) hidden layers. These layers apply a convolution operation to the input before signaling the result to the next layer. Each convolutional node may process data for a limited field of input (i.e., the receptive field). During a forward pass of the CNN, filters at each layer may be convolved across the input volume, computing the dot product between the filter and the input. During the training process, the filters may be modified so that they activate when they detect a particular feature within the input.

Processor(s) 110 may also include one or more sensor processing units associated with LiDAR system 102, camera(s) 104, and/or sensor(s) 108. For example, processor(s) 110 may include one or more image signal processors associated with camera(s) 104 and/or sensor(s) 108, and/or a navigation processor associated with sensor(s) 108, which may include satellite-based positioning system components (e.g., Global Positioning System (GPS) or Global Navigation Satellite System (GLONASS)) as well as inertial positioning system components. Sensor(s) 108 may include direct depth sensing sensors, which may function to determine a depth of or distance to objects within the environment surrounding processing system 100 (e.g., surrounding a vehicle).

Processing system 100 also includes memory 160, which is representative of one or more static and/or dynamic memories, such as a dynamic random-access memory, a flash-based static memory, and the like. In this example, memory 160 includes computer-executable components, which may be applied by one or more of the aforementioned components of processing system 100.

Examples of memory 160 include one or more memories, such as random access memory (RAM), read-only memory (ROM), electrically erasable programmable ROM (EEPROM), compact disk ROM (CD-ROM), and/or another kind of hard disk. Examples of memory 160 include solid state memory and a hard disk drive. In some examples, memory 160 is used to store computer-readable, computer-executable software including instructions that, when applied, cause a processor to perform various functions described herein. In some cases, memory 160 contains, among other things, a basic input/output system (BIOS) which controls basic hardware or software operation such as the interaction with peripheral components or devices. In some cases, a memory controller operates memory cells of memory 160. For example, the memory controller can include a row decoder, column decoder, or both. In some cases, memory cells within memory 160 store information in the form of a logical state.

Processing system 100 may be configured to perform techniques for extracting features from 2D camera images 168 and 3D point cloud frames 166, processing the features, fusing the features, or any combination thereof. For example, processor(s) 110 may include stixel unit 140. Stixel unit 140 may be implemented in software, firmware, and/or any combination of hardware described herein. As will be described in more detail below, Stixel unit 140 may be configured to execute machine learning model 170. Stixel unit 140 may be configured to obtain 2D image data, such as 2D camera images 168. Stixel unit 140 may be configured to obtain 3D point cloud data, such as 3D point cloud frames 166. For example, stixel unit 140 may be configured to receive 2D camera images 168 and 3D point cloud frames 166 directly from camera(s) 104 and LiDAR system 102, respectively, or from memory 160. Stixel unit 140 may be configured to generate one or more multimodal fused 3D stixels based on the 2D image data and the 3D point cloud data. Control unit 142 may control operation of a vehicle based on the one or more multimodal fused 3D stixels.

In general, stixel unit 140 may fuse features corresponding to 3D point cloud frames 166 and features corresponding to 2D camera images 168 in order to combine image data corresponding to one or more objects within a 3D space with position data corresponding to the one or more objects. For example, each camera image of the plurality of 2D camera images 168 may comprise a 2D array of pixels that includes image data corresponding to one or more objects, such as a ground boundary or a boundary between an object like a building and the ground. Each point cloud frame of the plurality of 3D point cloud frames 166 may include a 3D multi-dimensional array of points corresponding to the one or more objects. However, points in 3D point cloud frames 166 may be much sparser than pixels in 2D camera images 168. Since the one or more objects are located in the same 3D space where processing system 100 is located, it may be beneficial to fuse features of the image data present in 2D camera images 168 that indicate information, such as edges or boundaries of objects, with features of the point cloud data present in the 3D point cloud frames 166 that indicate a location of the one or more objects within the 3D space. In some examples, image data may include at least some information that position data does not include, and position data may include at least some information that image data does not include.

Fusing features of 2D camera images 168 and features of 3D point cloud frames 166 may provide a more comprehensive view of a 3D environment corresponding to processing system 100 as compared with analyzing features of image data and features of position data separately. For example, the plurality of 3D point cloud frames 166 may indicate an object in front of a processing system 100, and stixel unit 140 may be able to predict an accurate stixel location which may better indicate free space around the object.

Generally, processing system 100 and/or components thereof may be configured to perform the techniques described herein. Note that processing system 100 of FIG. 1 is just one example, and in other examples, alternative processing system 100 with more, fewer, and/or different components may be used.

In some examples, a machine learning model may be trained “off-line” such as before deployment to processing system 100. For example, external processing system 180 may train machine learning model 196. In some examples, external processing system 180 may be a cloud-based system.

External processing system 180 may include one or more processor(s) 190. Processor(s) 190 may be similar to processor(s) 110 described above. External processing system 180 may include stixel unit 194 which may be similar to stixel unit 140 and may execute machine learning model 196. Processor(s) may train machine learning model 196 as described herein to facilitate machine learning model 196 to accurately predict a location of a 3D stixel, including a location of the bottom of the 3D stixel at a ground boundary or edge. In some examples, machine learning model 170 represents a trained version of machine learning model 196.

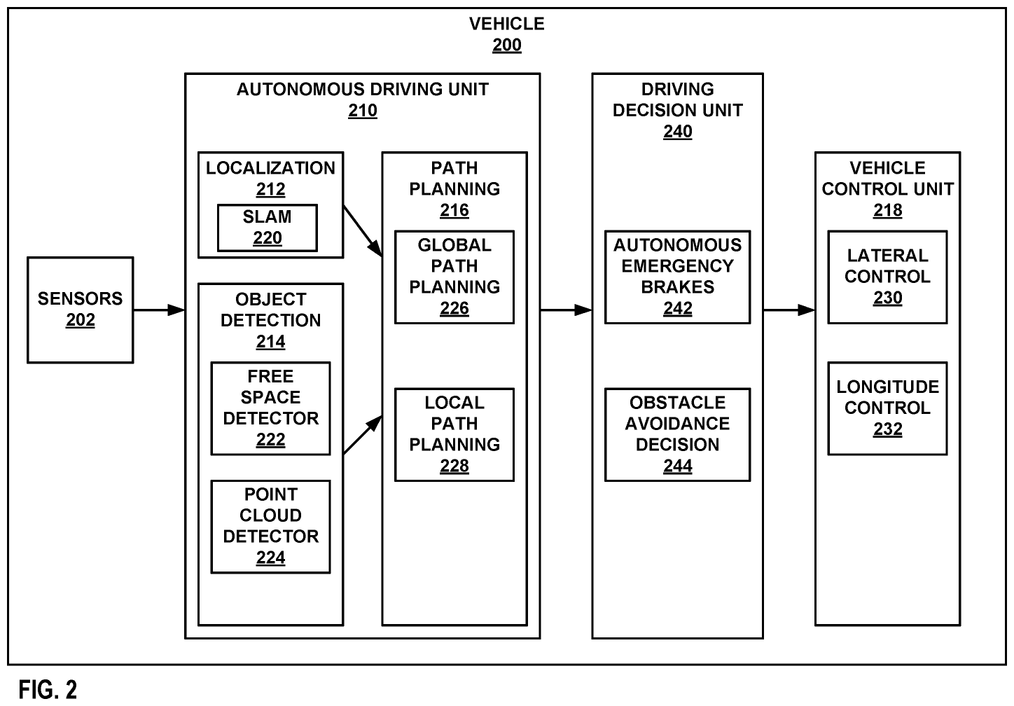

FIG. 2 is a block diagram illustrating example vehicle systems according to one or more aspects of this disclosure. Vehicle 200 may include processing system 100 of FIG. 1, which may form all of, or part of, any combination of units described with respect to FIG. 2.

Vehicle 200 may include sensors 202, autonomous driving unit 210, driving decision unit 240, and vehicle control unit 218. Sensors 202 may include LiDAR sensor(s) similar to LiDAR system 102 and camera sensor(s) similar to camera(s) 104 of FIG. 1. Sensors 202 may include radar sensors, global positioning satellite (GPS) sensors, and/or the like, which may be similar to sensors of sensor(s) 108 of FIG. 1. Autonomous driving unit 210 may include localization unit 212, object detection unit 214, path planning unit 216, and vehicle control unit 218. A number of units within autonomous driving unit 210 may operate based on input from sensors 202. For example, localization unit 212 and object detection unit 214 may utilize information from sensors 202.

Localization unit 212 may include simultaneous localization and mapping (SLAM) unit 220. SLAM unit 220 may determine a globally consistent representation of the environment around vehicle 200, for example, based on input data from sensors 202. Object detection unit 214 may include free space detector 222 and point cloud detector 224 which may be used to detect objects within an environment surrounding vehicle 200. Free space detector 222 may estimate or detect free space in the surrounding environment. Point cloud detector 224 may generate a point cloud based on, for example, LiDAR and/or radar data. Free space detector 222 may generate stixels as described herein as part of estimating free space.

Path planning unit 216 may include global path planning unit 226 and local path planning unit 228. Global path planning unit 226 may plan a path based on an assumption of a static environment around vehicle 200 for example, including roads, sidewalks, buildings, and the like. Local path planning unit 228 may plan a path based on dynamic information such as sensor data indicative of changes in the environment around vehicle 200. As path planning unit 216 determines the path which vehicle 200 may travel, it may be desirable to have accurate data input to path planning unit 216, such as data output by free space detector 222.

Driving decision unit 240 may be configured to make decisions about how vehicle 200 should respond based on output of the path planning unit 216. Driving decision unit 240 may include autonomous emergency brakes unit 242 and/or obstacle avoidance decision unit 244. Autonomous emergency brakes unit 242 may be configured to determine whether or not to apply emergency brakes of vehicle 200 to avoid a collision. Obstacle avoidance decision unit 244 may be configured to determine how to avoid an obstacle.

Vehicle control unit 218, which may be similar to control unit 142 of FIG. 1, may include lateral control unit 230 and longitude control unit 232. Lateral control unit 230 may be configured to, based on the output of driving decision unit 240, control the lateral direction of the maneuvering of vehicle 200. For example, lateral control unit 230 may control steering of vehicle 200 in one direction or another direction to avoid an obstacle or otherwise navigate vehicle 200. Longitude control unit 232 may be configured to control the longitudinal direction of the maneuvering of vehicle 200 via vehicle control unit 218. For example, longitude control unit 232 may control a throttle system and/or braking system to accelerate or apply brakes for vehicle 200.

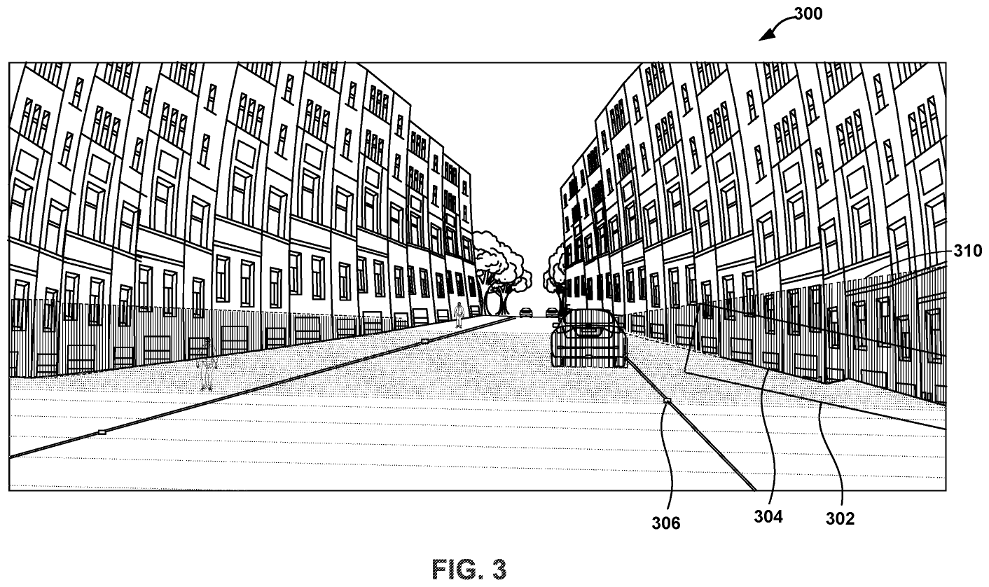

FIG. 3 is a conceptual diagram illustrating an example of 3D point cloud data and 3D stixels overlaid on 2D image data according to one or more aspects of this disclosure. In the example of FIG. 3, regions at a close range and at a far range that have a relatively high point cloud sparsity (or low point cloud density). Irregular surfaces such as curbs and vehicles, along with relatively poor spatial resolution of LiDAR sensors, may lead to relatively poor spatial sampling of free space boundaries. A lower number of points of the point cloud data may result in relatively poor estimation of stixel ground points as seen in the stixels shown in rectangle 302. In rectangle 302 many of the vertical stixels shown do not touch expected ground edge, but rather are “hanging” with the bottom of the stixel floating above the ground edge.

In the example of FIG. 3, point cloud data is shown as points, such as point 308 with some point cloud data being represented by stixels, such as stixel 310. The stixels of FIG. 3 are shown as vertical sticks against the buildings on either side of 2D image 300.

The smaller boxes, such as box 306, represent regions with missing 3D points on free space boundaries. The missing 3D points within such regions may lead to relatively poor free space determination and stixel extraction, which may be concerning in an autonomous driving context. These boxes, also seen on the sidewalk, may demonstrate missing stixels due to over filtering of the curb along with the ground.

The bottoms of several hanging stixels, such as stixel 310, are shown in rectangle 302. Hanging stixels may occur due to points from LiDAR signals not hitting the ground close to, e.g., building pillars, as shown in FIG. 3. For example, LiDAR signals may not hit the ground close to the building pillars due to LiDAR point cloud sparsity and spatial resolution issues. Such sparsity and/or spatial resolution issues may change with extrinsic of different LiDAR sensors, vehicle shape, road surface, and/or orientation of the sensors and/or vehicle. Line 304 represents expected free space boundaries. However, it can be seen that the bottom of many of the stixels in that area, including stixel 310, are hanging stixels the bottom of many of these stixels do not meet the expected free space boundaries.

Due to relatively poor spatial resolution of LiDAR data, points may not precisely impact a bottom of an object that defines a free space boundary. However, camera images may have a relatively high resolution and capture image data indicative of the bottom of such objects as seen in edges as indicated in label gradients.

Relatively small, linear objects, such as curbs, may have very few LiDAR data points at relatively large and small distances from the ego vehicle based on the configuration of the LiDAR sensors. However, image data may accurately show such objects.

Typical LiDAR point clouds are sparse, therefore a typical LiDAR point cloud may not have enough resolution for vehicle 200 to detect or determine fine differences in heights, such as between a road and a sidewalk, especially for far away structures where LiDAR sparsity may increase. However, image-based 2D cues provide a much denser resolution than the LiDAR data. However, image-based 2D cues fail to provide precise depth information when encountering uneven road textures, such as due to shadows, potholes, lane markings, road restoration, or the like.

As such, there may be an opportunity for vehicle 200 to use a camera/LiDAR (or camera/radar) multimodal perception setup, to more accurately estimate free space boundaries (and thus the intersection stixels with local ground) under the effect of variable point cloud density, using intermediate level fusion of features from camera/LiDAR sensors.

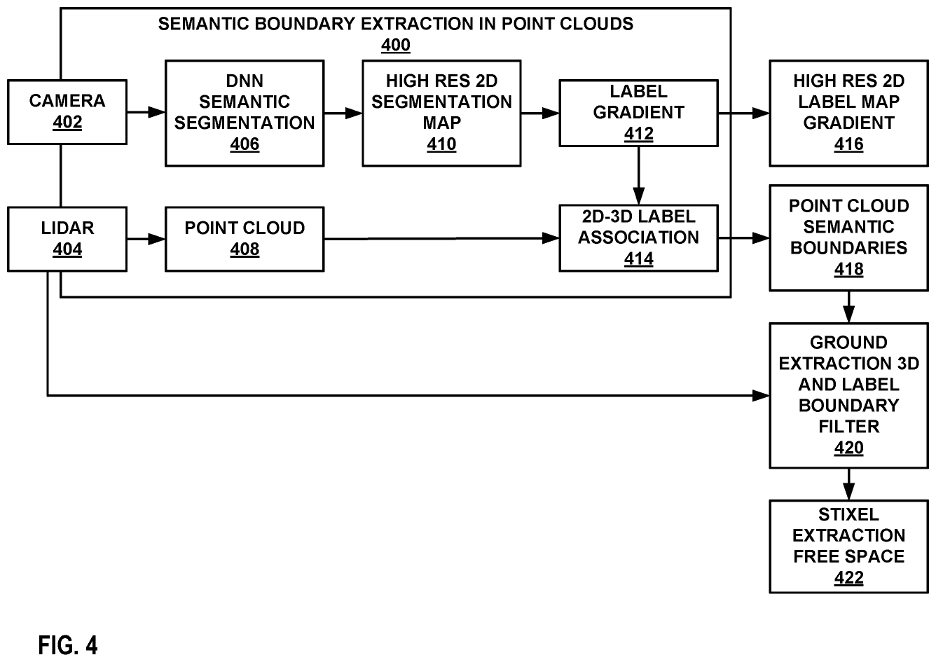

FIG. 4 is a block diagram of example stixel extraction techniques according to one or more aspects of this disclosure. Vehicle 200 may perform a semantic boundary extraction in point clouds 400. For example, vehicle 200 may extract semantic boundaries from point cloud data. Vehicle 200 may obtain 2D image data from camera 402. Vehicle 200 may perform a semantic segmentation 406 on the 2D image data to generate a high resolution 2D segmentation map 410. In some examples, vehicle 200 may use a DNN to perform the semantic segmentation. Vehicle 200 may perform a label gradient operation 412 to determine boundaries between segments in high resolution 2D segmentation map 410 and output high resolution 2D label map gradient 416 reflective of such boundaries. High resolution 2D label map gradient 416 may include a 2D high resolution boundary image.

Vehicle 200 may also obtain LiDAR data from LiDAR sensor(s) 404 and generate point cloud 408 based on the obtained LiDAR data. Vehicle 200 may perform 2D-3D label association 414 to generate a reprojection of 3D points of point cloud 408 into a 2D high resolution boundary image to obtain labels of points in 3D. The output of 2D-3D label association 414 may be point cloud semantic boundaries 418.

Vehicle 200 may perform a ground extraction 3D and label boundary filtering operation 420. Since all boundaries may be present in point cloud semantic boundaries 418, a ground extraction model, such as that of ground extraction 3D and label boundary filtering operation 420, may determine a ground plane and/or remove boundaries which are not in proximity with the ground plane (e.g., a bottom of a vehicle).

Vehicle 200 may perform a stixel extraction free space operation 422 which may create 3D stixels by voxelizing the filtered point cloud from ground extraction 3D and label boundary filter 420 and by computing a gradient in a z (depth) direction.

However, the techniques of FIG. 4 may not resolve the hanging stixel issue because the resolution of point cloud 408 is relatively low and there are sparse regions in the 3D data, leading to hanging stixels. According to the techniques of this disclosure, vehicle 200 may address the hanging stixel issue by creating or generating new 3D points including depth information based on information obtained from camera image 2D features. For example, vehicle 200 may predict 3D points for a bottom of a stixel at a ground boundary identified from 2D images.

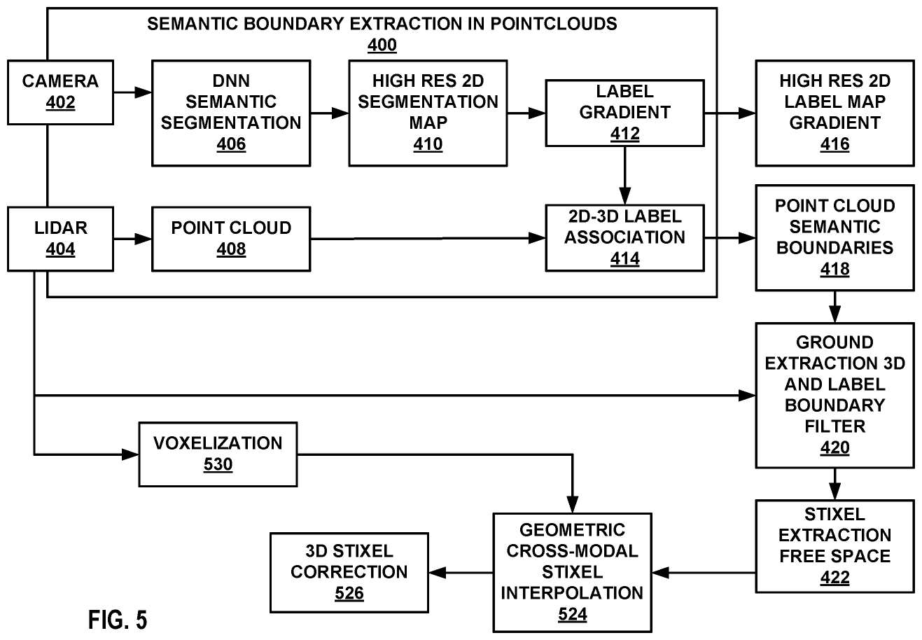

FIG. 5 is a block diagram illustrating example techniques for generating 3D stixel correction data for training a machine learning model according to one or more aspects of this disclosure. Boxes in FIG. 5 having the same number as boxes in FIG. 4 may operate in the same manner as described with respect to FIG. 4 and are not redescribed for sake of brevity. While described with respect to external processing system 180, the techniques of FIG. 5 may be performed by any of, or any combination of, external processing system 180, processing system 100, and/or vehicle 200.

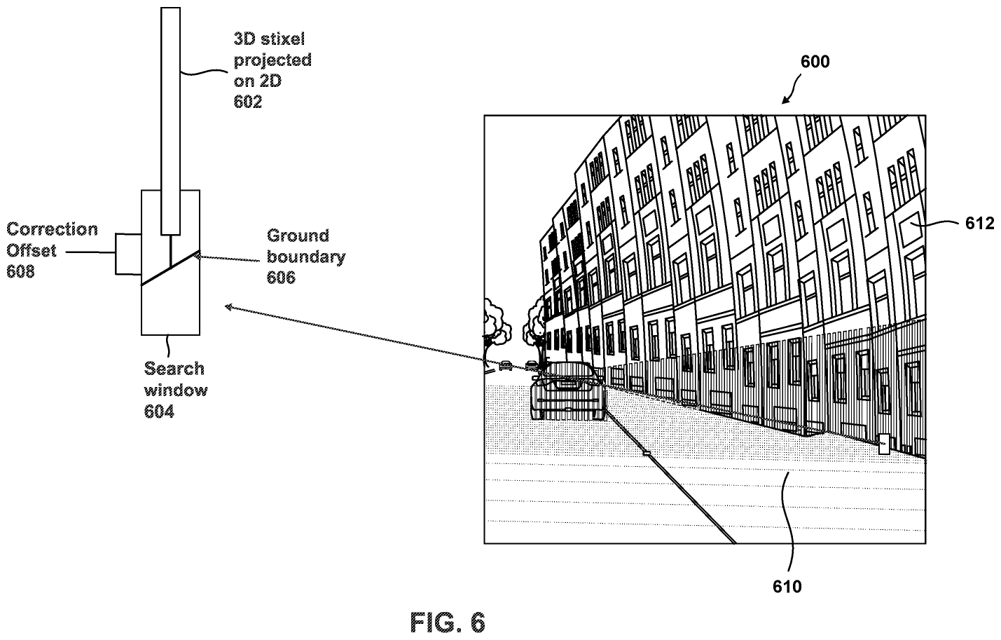

In the example of FIG. 5, external processing system 180 may execute a voxelization operation 530 on 3D point cloud data from LiDAR sensor(s) 404. External processing system 180. External processing system 180 may perform a geometric cross-modal stixel interpolation 524 based on the output of voxelization operation 530 and stixel extraction free space operation 422. External processing system 180 may use the output of geometric cross-modal stixel interpolation 524 to determine a 3D stixel correction 526. 3D stixel correction 526 may be used to train a machine learning model (e.g., machine learning model 196 of FIG. 1) to predict 3D stixels having a bottom edge in contact with a ground border, rather than generating hanging stixels. External processing system 180 may determine 3D stixel correction 526 for stixels for a large volume of point cloud data and corresponding camera images so as to generate training data for a large volume of different scenes and navigation situations from which to train machine learning model 196. The operation of geometric cross-modal stixel interpolation 524 is described in more detail with respect to FIG. 6.

FIG. 6 is a conceptual diagram illustrating example techniques for determining a 3D stixel correction offset according to one or more aspects of this disclosure. External processing system 180 (and/or processing system 100 and/or vehicle 200) may perform the following as part of, or in conjunction with, geometric cross-modal stixel interpolation 524 of FIG. 5.

External processing system 180 may project 3D stixels, such as 3D stixel 602, on 2D images (e.g., 2D image 600) using calibration (e.g., a perspective transform). The bottom of stixel 602 may be considered as a prior ground position obtained from 3D features, even though the bottom of stixel 602 may not align with a ground boundary in 2D image 600. External processing system 180 may create a 3D search window at or near the bottom of each stixel in 3D space. External processing system 180 may dynamically set the size of that 3D search window based on an average depth of the current stixel being processed. In some examples, stixels closer to processing system 100 should have a larger 3D search window size than stixels further away from processing system 100.

External processing system 180 may project the 3D search window in 2D to generate search window 604. Because external processing system 180 projects the 3D search window to 2D, the mapping between the 3D and 2D search windows is known to external processing system 180.

External processing system 180 may exploit appearance features to search for a ground boundary 606 inside search window 604 in the 2D space. For example, appearance features may include edges between objects in 2D image 600, such as between sidewalk 610 and building 612. Additionally, or alternatively, appearance features may include curbs and boundaries of curbs, which are often difficult to detect in a sparse point cloud. External processing system 180 may determine a correction offset 608 in 2D. Correction offset 608 may be an offset between ground boundary 606 and the bottom of stixel 602. External processing system 180 may project correction offset 608 back to 3D using the known mapping between the 3D and 2D search windows.

External processing system 180 may thereby generate 3D stixel correction 526 using the reprojected offset. For example, repositioning a 3D stixel using 3D stixel correction 526 may thereby more accurately identify the ground position based on prior information from 3D data and fused features from 2D image 600. As such, 3D stixel correction 526 may be used to train machine learning model 196 (FIG. 1) to more accurately predict stixels.

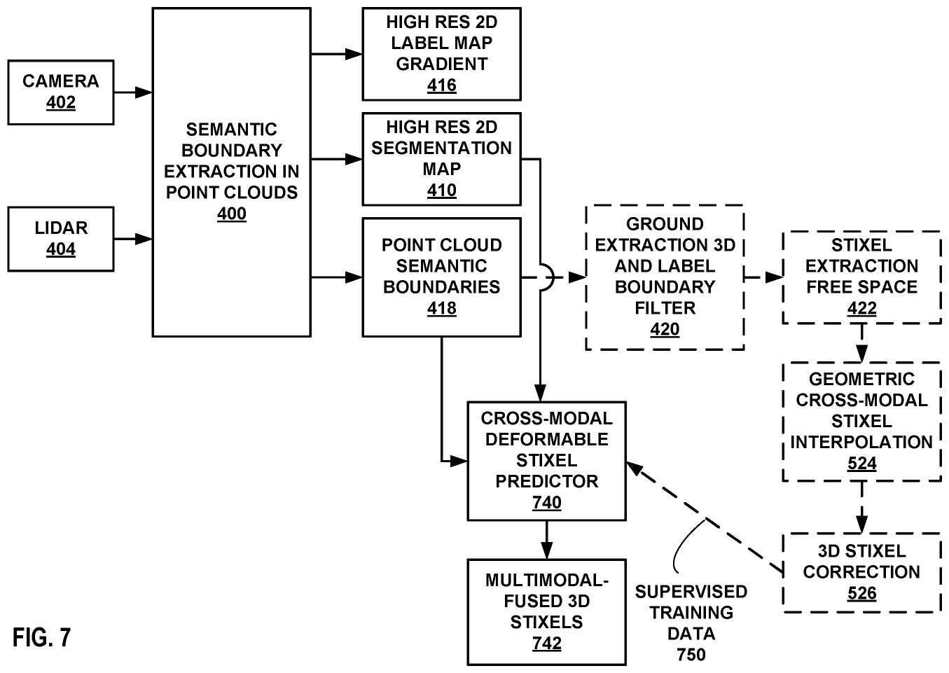

FIG. 7 is a block diagram illustrating example cross-modal deformable stixel prediction techniques according to one or more aspects of this disclosure. Boxes of FIG. 7 labeled the same as boxes of FIGS. 4 and/or 5 may perform in the same manner described with respect to FIGS. 4 and/or 5 and are not redescribed for sake of brevity. The techniques of FIG. 7 may be performed by any of, or any combination of external processing system 180, processing system 100, and/or vehicle 200. Lines and boxes shown with dashed lines represent operations performed during training of cross-modal deformable stixel predictor 740. When cross-modal deformable stixel predictor 740 is not being trained (e.g., after cross-modal deformable stixel predictor 740 is fully trained), such operations need not be performed.

External processing system 180 may use an output of 3D stixel correction 526, e.g., a 3D correction offset, as supervised training data 750 for a cross-modal deformable stixel predictor 740. Cross-modal deformable stixel predictor 740 may include a deformable kernel due to differing degrees of sparseness of 3D point cloud data at different distances from LiDAR sensors. Cross-modal deformable stixel predictor 740 may be an example of machine learning model 196 and/or machine learning model 170. Cross-modal deformable stixel predictor 740 may use high resolution 2D segmentation map 410, and point cloud semantic boundaries 418 to predict stixels, such as multimodal-fused 3D stixels 742, including a ground boundary of such stixels so as to avoid using hanging stixels to determine free space for navigation. In some examples, a trained cross-modal deformable stixel predictor 740, trained using 3D stixel correction 526, may be deployed to processing system 100 as machine learning model 170 and/or be deployed to vehicle 200.

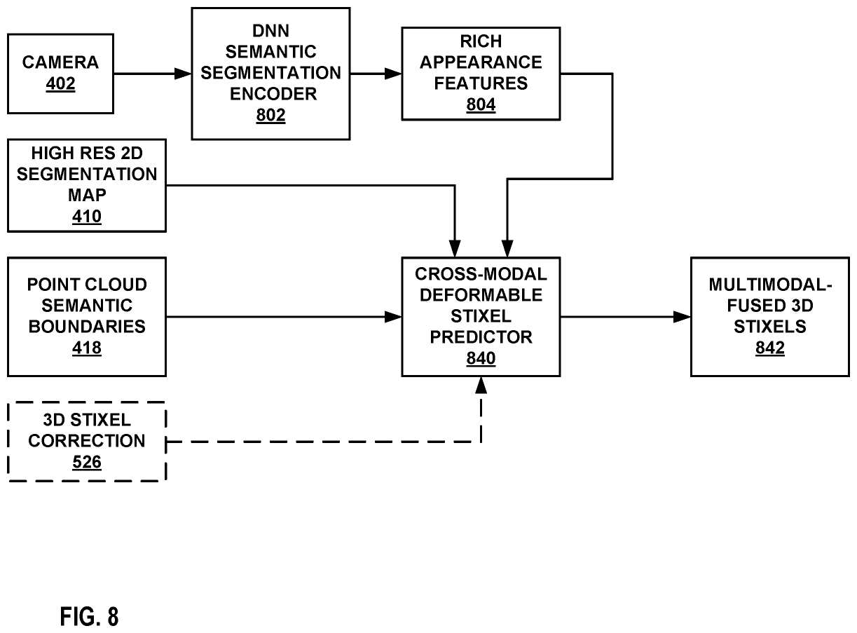

FIG. 8 is a block diagram illustrating an example architecture for performing cross-modal deformable stixel prediction according to one or more aspects of this disclosure. In order to maintain the same neighboring 3D points, which may have different sparsity, when predicting a 3D stixel, cross-modal deformable stixel predictor 840 (which may be an example of, or similar to, cross-modal deformable stixel predictor 740 of FIG. 7) may include a deformable kernel that learns variable offsets during a training process described earlier herein and as represented by 3D stixel correction 526 shown in dashed lines. The deformable kernel thus adapts to varying non-convex geometries of ground surfaces, dynamic vehicles, and/or objects in the scene.

The deformable kernel also obtains as input, from DNN semantic segmentation encoder 802, rich appearance features 804, which may include image-based features, to help locate positions in 3D to be invariant to changes in illumination and/or contrast within the same class and/or segment in high resolution 2D segmentation map 410. Rich appearance features 804 may include edges, boundaries, curbs, objects footprints. DNN semantic segmentation encoder 802 may form all or part of DNN semantic segmentation 406 of FIGS. 4 and 5.

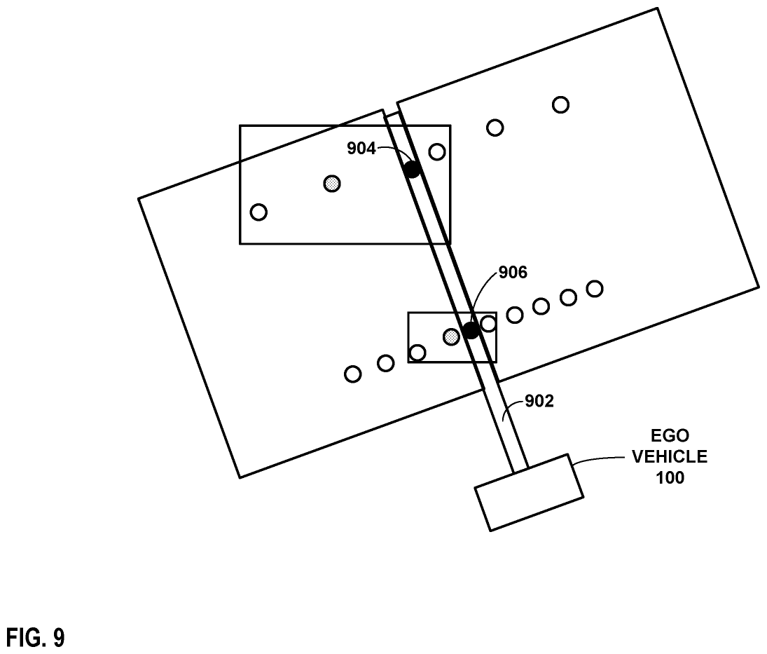

FIG. 9 is a conceptual diagram illustrating an example cross-modal deformable convolution according to one or more aspects of this disclosure. Points in a point cloud frame from different layers in LiDAR data may have varying sparsity and thus distance from the missed free space boundary 902. Points 904 and 906 may represent points of multimodal-fused 3D stixels 842. Cross-modal deformable stixel predictor 740 may include a DNN. FIG. 9 depicts the cross-modal deformable convolution in 2 different cases where the distance to the actual free space boundary is variable due to change in point cloud resolution with distance. For example, the point cloud resolution is more sparse at points near the location of point 904, as shown by the distance between neighboring points, than the point cloud resolution is at points near the location of point 906.

External processing system 180 using geometric cross-modal stixel interpolation 524 may provide an annotation free technique to obtain corrected stixels and/or stixel offsets that can be used for supervision of the cross-modal deformable stixel predictor 740 and/or 840. For example, the techniques of this disclosure may locate points in point cloud 408 having associated stixels from the techniques set forth with respect to FIG. 4 and correct those hanging stixels which have no alignment with ground edges. In some examples, processing circuitry 100 or vehicle 200 using cross-modal deformable stixel predictor 740 and/or 840 may predict interpolated points of, or correct, only those stixels which have no alignment with image edges, such as 2D ground boundaries.

For example, external processing system 180, to train cross-modal deformable stixel predictor 740 and/or 840, may generate a search window in an image around a reprojected 3D point corresponding to a bottom edge of a stixel. External processing system 180 100 may consider a stixel as being precise and not needing correction if the bottom edge of the stixel is aligned to an image segmentation map edge. When the bottom edge of a stixel is not aligned to an image segmentation map edge, external processing system 180 may select the pixel which corresponds to the border of labels. Processing system 100 and/or vehicle 200 implementing cross-modal deformable stixel predictor 740 and/or 840 may interpolate the 3D line segment so as to be proportional to the 2D stixel segment.

In some examples, a geometric stixel interpolation technique, by itself, may not generalize well due to the heuristic nature of such a technique. As such, cross-modal deformable stixel predictor 740 and/or 840, which may include a DNN, may be trained to infer the spatial neighborhood in varying point cloud sparsity to predict an offset of the new point in 3D corresponding to the bottom edge of a stixel.

The techniques of this disclosure may provide for the detection of stixels which are not aligned with ground by using image features. For example, the techniques of this disclosure may use a deformable kernel that is adaptive to the irregular sampling at different distances and shapes of objects in a scene, to teach an adaptive kernel to fuse point cloud and image features to improve the location of a stixel bottom edge.

Conventional free space estimation methods rely on manual annotations which are expensive to obtain. The techniques of this disclosure do not require any annotation and the output is robust because it relies on both 3D cues and 2D features, combining the benefits of accurate depth measurement from LiDAR and dense features from camera images, while each modality helps overcome the limitations of the other.

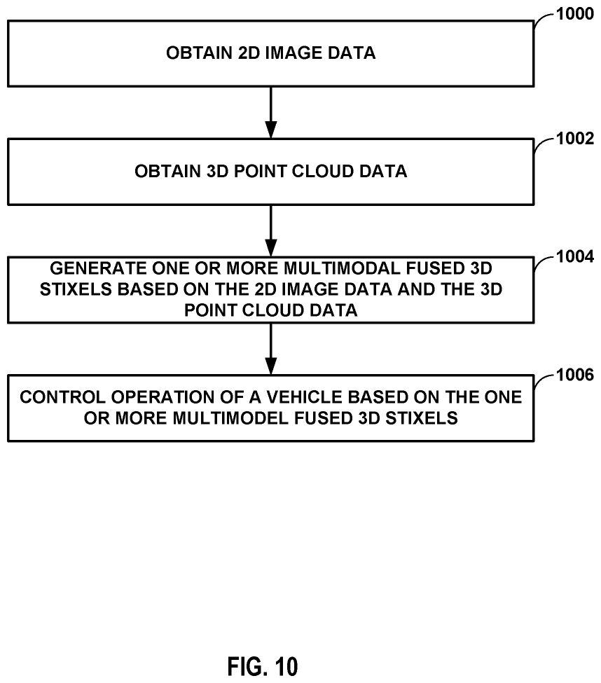

FIG. 10 is a flow diagram illustrating example vehicle operation techniques in accordance with one or more aspects of this disclosure. While the techniques of FIG. 10 are described with respect to processing system 100, the techniques of this disclosure are applicable to any device (e.g., vehicle, robot, etc.) capable of performing these techniques, such as vehicle 200 (FIG. 2).

Processor(s) 110 may obtain 2D image data (1000). For example, processor(s) 110 may receive 2D camera images 168 from camera(s) 104 or retrieve 2D camera images 168 from memory 160. Processor(s) 110 may obtain 3D point cloud data (1002). For example, processor(s) 110 may receive 3D point cloud data 166 from LiDAR system 102 or retrieve 3D point cloud data 166 from memory 160.

Processor(s) 110 may generate one or more multimodal fused 3D stixels based on the 2D image data and the 3D point cloud data (1004). For example, processor(s) 110, in the process of determining free space, may generate one or more multimodal fused 3D stixels from 3D point cloud frames 166 and 2D camera images 168.

Processor(s) 110 may control operation of vehicle 200 based on the one or more multimodal fused 3D stixels (1006). For example, processing circuitry 100 may control navigation of vehicle 200 in free space based on the one or more multimodal fused 3D stixels used to determine the free space.

In some examples, as part of generating the one or more multimodal fused 3D stixels, processor(s) 110 may execute a machine learning model, the machine learning model having been trained with a 3D stixel correction.

In some examples, as part of controlling the operation of processing system 100 based on the one or more multimodal fused 3D stixels, processor(s) 110 may determine a free space based on the one or more multimodal fused 3D stixels and control the operation of vehicle 200 within the free space. In some examples, as part of controlling the operation of vehicle 200 within the free space, processing circuitry 100 may control at least one of a steering of vehicle 200, an acceleration of vehicle 200, or a braking of vehicle 200.

In some examples, the machine learning model comprises a cross-modal deformable stixel predictor. In some examples, as part of executing the machine learning model, processor(s) 110 may apply a deformable kernel to a 2D segmentation map and point cloud semantic boundaries. In some examples, the machine learning model includes a deep neural network.

In some examples, processing system 100 includes a light detection and ranging (LiDAR) system (e.g., LiDAR system 102) configured to capture the 3D point cloud data (e.g., 3D point cloud frames 166) and a camera (e.g., of camera(s) 104) configured to capture the 2D image data (e.g., 2D camera images 168).

In some examples, 3D stixel correction 526 includes a projected correction offset and the projected correction offset is based on a projected a 3D stixel on a 2D image, a generated search window based on a bottom of the 3D stixel in a 3D space, a projection of the search window in a 2D space, a determination of a ground boundary inside the search window in the 2D space, a determination of a correction offset in the 2D space, and a projection of the correction offset into the 3D space.

In some examples, 3D stixel correction 526 includes a projected correction offset and processor(s) 110 may project a 3D stixel on a 2D image of the 2D image data. Processor(s) 110 may generate a search window based on a bottom of the 3D stixel in a 3D space. Processor(s) 110 may project the search window in a 2D space, the 2D space corresponding with the 2D image. Processor(s) 110 may determine, based on one or more appearance features in the 2D image, a ground boundary inside the search window in the 2D space. Processor(s) 110 may determine a correction offset in the 2D space between the ground boundary and a bottom of the projected 3D stixel the bottom of the projected 3D stixel corresponding to the bottom of the 3D stixel. Processor(s) 110 may project the correction offset into the 3D space. Processor(s) 110 may train machine learning model 170 based on the projected correction offset.

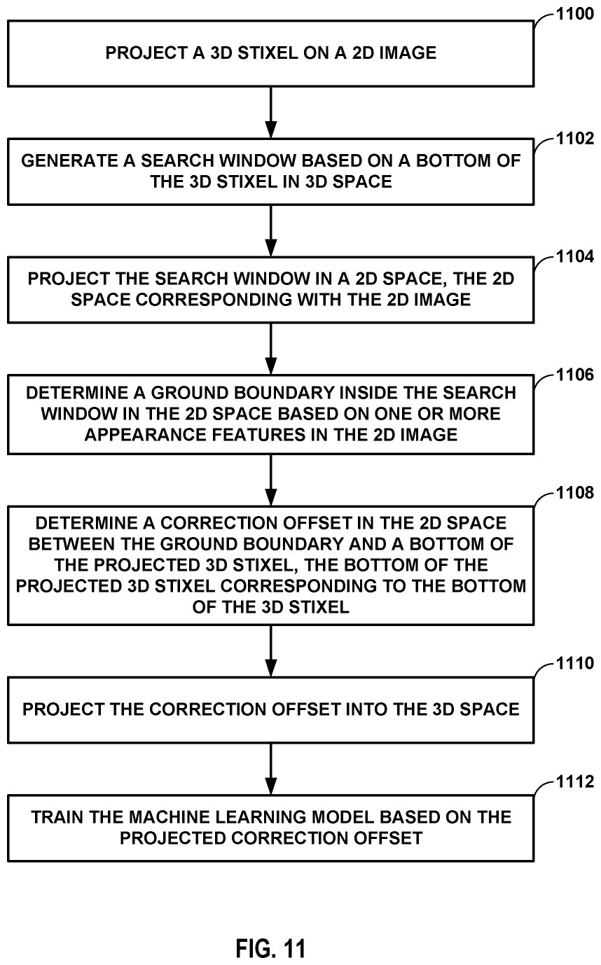

FIG. 11 is a flow diagram illustrating machine learning model training techniques according to one or more aspects of this disclosure. While the techniques of FIG. 11 are described with respect to external processing system 180, the techniques of this disclosure are applicable to any device (e.g., vehicle, robot, etc.) capable of performing these techniques, such as processing system 100 (FIG. 1) and/or vehicle 200 (FIG. 2).

External processing system 180 may project a 3D stixel on a 2D image (1100). For example, external processing system 180 may generate a 3D stixel based on 3D point cloud data, such as 3D point cloud frames 166, and project that 3D stixel onto a 2D image, such as 2D image 600 (FIG. 6).

External processing system 180 may generate a search window (e.g., search window 604) based on a bottom of the 3D stixel (e.g., 3D stixel 602) in a 3D space (1102). For example, external processing system 180 may generate a search window around, including, or starting from a bottom of the 3D stixel.

External processing system 180 may project the search window in a 2D space, the 2D space corresponding with the 2D image (1104). For example, external processing system 180 may project search window 604 onto 2D image 600.

External processing system 180 may determine a ground boundary inside the search window in the 2D space, based on one or more appearance features in the 2D image (1106). For example, external processing system 180 may determine ground boundary 606 based on a determined edge between sidewalk 610 and building 612 in 2D image 600.

External processing system 180 may determine a correction offset in the 2D space between the ground boundary and a bottom of the projected 3D stixel, the bottom of the projected 3D stixel corresponding to the bottom of the 3D stixel (1108). For example, external processing system 180 may determine correction offset 608 between ground boundary 606 and the bottom of projected 3D stixel 602 in the 2D space so as to align the bottom of projected 3D stixel 602 with ground boundary 606.

External processing system 180 may project the correction offset into the 3D space (1110). For example, processing system 180 may use the manner in which external processing system 180 projected the 3D stixel and/or search window into 2D space to project correction offset 608 into the 3D space.

External processing system 180 may train the machine learning model based on the projected corrected offset (1112). For example, external processing system 180 may train the machine learning model using the projected corrected offset to generate more accurate 3D stixels, thereby improving the accuracy of free space and improving the safety of navigation within the free space of an ego vehicle.

In some examples, a size of the search window is based on an average depth of the 3D stixel. In some examples, the correction offset includes a distance between a ground boundary and a bottom of the stixel. In some examples, the one or more appearance features include one or more edges. In some examples, the machine learning model includes a cross-modal deformable stixel predictor. In some examples, the machine learning model includes a deformable kernel. In some examples, the machine learning model includes a deep neural network.

Examples in the various aspects of this disclosure may be used individually or in any combination.

This disclosure includes the following clauses.

Clause 1. A system for controlling operation of a vehicle comprising: one or more memories configured to store a machine learning model; and one or more processors communicatively coupled to the one or more memories, the one or more processors being configured to: obtain two-dimensional (2D) image data; obtain three-dimensional (3D) point cloud data; generate one or more multimodal fused 3D stixels based on the 2D image data and the 3D point cloud data, wherein as part of generating the one or more multimodal fused 3D stixels, the one or more processors are configured to execute a machine learning model, the machine learning model having been trained with a 3D stixel correction; and control operation of a vehicle based on the one or more multimodal fused 3D stixels.

Clause 2. The system of clause 1, wherein as part of controlling the operation of the vehicle based on the one or more multimodal fused 3D stixels, the one or more processors are configured to: determine a free space based on the one or more multimodal fused 3D stixels; and control the operation of the vehicle within the free space.

Clause 3. The system of clause 2, wherein as part of controlling the operation of the vehicle within the free space, the one or more processors are configured to control at least one of a steering of the vehicle, an acceleration of the vehicle, or a braking of the vehicle.

Clause 4. The system of any of clauses 1-3, wherein the machine learning model comprises a cross-modal deformable stixel predictor.

Clause 5. The system of clause 4, wherein the as part of executing the machine learning model, the one or more processors are configured to apply a deformable kernel to a 2D segmentation map and point cloud semantic boundaries.

Clause 6. The system of clause 4 or clause 5, wherein the machine learning model comprises a deep neural network.

Clause 7. The system of any of clauses 1-6, further comprising: a light detection and ranging (LiDAR) system configured to capture the 3D point cloud data; and a camera configured to capture the 2D image data.

Clause 8. The system of clause 7, further comprising the vehicle.

Clause 9. The system of any of clauses 1-8, wherein the 3D stixel correction comprises a projected correction offset and wherein the projected correction offset is based on a projected a 3D stixel on a 2D image, a generated search window based on a bottom of the 3D stixel in a 3D space, a projection of the search window in a 2D space, a determination of a ground boundary inside the search window in the 2D space, a determination of a correction offset in the 2D space, and a projection of the correction offset into the 3D space.

Clause 10. The system of any of clauses 1-8, wherein the 3D stixel correction comprises a projected correction offset and wherein the one or more processors are further configured to: project a 3D stixel on a 2D image of the 2D image data; generate a search window based on a bottom of the 3D stixel in a 3D space; project the search window in a 2D space, the 2D space corresponding with the 2D image; determine, based on one or more appearance features in the 2D image, a ground boundary inside the search window in the 2D space; determine a correction offset in the 2D space between the ground boundary and a bottom of the projected 3D stixel the bottom of the projected 3D stixel corresponding to the bottom of the 3D stixel; project the correction offset into the 3D space; and
train the machine learning model based on the projected correction offset.

Clause 11. A system for training a machine learning model, the system comprising: one or more memories configured store the machine learning model; and one or more processors communicatively coupled to the one or more memories, the one or more processors being configured to: project a 3D stixel on a 2D image; generate a search window based on a bottom of the 3D stixel in a 3D space; project the search window in a 2D space, the 2D space corresponding with the 2D image; determine a ground boundary inside the search window in the 2D space, based on one or more appearance features in the 2D image; determine a correction offset in the 2D space between the ground boundary and a bottom of the projected 3D stixel, the bottom of the projected 3D stixel corresponding to the bottom of the 3D stixel; project the correction offset into the 3D space; and train the machine learning model based on the projected correction offset.

Clause 12. The system of clause 11, wherein a size of the search window is based on an average depth of the 3D stixel.

Clause 13. The system of clause 11 or clause 12, wherein the correction offset comprises a distance between a ground boundary and a bottom of the 3D stixel.

Clause 14. The system of any of clauses 11-13, wherein the one or more appearance features comprise one or more edges of objects.

Clause 15. The system of any of clauses 11-14, wherein the machine learning model comprises a cross-modal deformable stixel predictor.

Clause 16. The system of clause 15, wherein the machine learning model comprises a deformable kernel.

Clause 17. The system of clause 15 or clause 16, wherein the machine learning model comprises a deep neural network.

Clause 18. A method for controlling operation of a vehicle, the method comprising: obtaining two-dimensional (2D) image data; obtaining three-dimensional (3D) point cloud data; generating one or more multimodal fused 3D stixels based on the 2D image data and the 3D point cloud data, wherein generating the one or more multimodal fused 3D stixels comprises executing a machine learning model, the machine learning model having been trained with a 3D stixel correction; and controlling operation of a vehicle based on the one or more multimodal fused 3D stixels.

Clause 19. The method of clause 18, wherein controlling operation of the vehicle based on the one or more multimodal fused 3D stixels comprises: determining a free space based on the one or more multimodal fused 3D stixels; and controlling operation of the vehicle within the free space.

Clause 20. The method of clause 19, wherein controlling operation of the vehicle within the free space comprises controlling at least one of a steering of the vehicle, an acceleration of the vehicle, or a braking of the vehicle.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit.

Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable gate arrays (FPGAs), or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A system for controlling operation of a vehicle comprising:
one or more memories configured to store a machine learning model; and
one or more processors communicatively coupled to the one or more memories, the one or more processors being configured to:
obtain two-dimensional (2D) image data;
obtain three-dimensional (3D) point cloud data;
generate one or more multimodal fused 3D stixels based on the 2D image data and the 3D point cloud data, wherein as part of generating the one or more multimodal fused 3D stixels, the one or more processors are configured to execute a machine learning model, the machine learning model having been trained with a 3D stixel correction; and
control operation of a vehicle based on the one or more multimodal fused 3D stixels.

2. The system of claim 1, wherein as part of controlling the operation of the vehicle based on the one or more multimodal fused 3D stixels, the one or more processors are configured to:
determine a free space based on the one or more multimodal fused 3D stixels; and
control the operation of the vehicle within the free space.

3. The system of claim 2, wherein as part of controlling the operation of the vehicle within the free space, the one or more processors are configured to control at least one of a steering of the vehicle, an acceleration of the vehicle, or a braking of the vehicle.

4. The system of claim 1, wherein the machine learning model comprises a cross-modal deformable stixel predictor.

5. The system of claim 4, wherein the as part of executing the machine learning model, the one or more processors are configured to apply a deformable kernel to a 2D segmentation map and point cloud semantic boundaries.

6. The system of claim 4, wherein the machine learning model comprises a deep neural network.

7. The system of claim 1, further comprising:
a light detection and ranging (LiDAR) system configured to capture the 3D point cloud data; and
a camera configured to capture the 2D image data.

8. The system of claim 7, further comprising the vehicle.

9. The system of claim 1, wherein the 3D stixel correction comprises a projected correction offset and wherein the projected correction offset is based on a projected a 3D stixel on a 2D image, a generated search window based on a bottom of the 3D stixel in a 3D space, a projection of the search window in a 2D space, a determination of a ground boundary inside the search window in the 2D space, a determination of a correction offset in the 2D space, and a projection of the correction offset into the 3D space.

10. The system of claim 1, wherein the 3D stixel correction comprises a projected correction offset and wherein the one or more processors are further configured to:
project a 3D stixel on a 2D image of the 2D image data;
generate a search window based on a bottom of the 3D stixel in a 3D space;
project the search window in a 2D space, the 2D space corresponding with the 2D image;
determine, based on one or more appearance features in the 2D image, a ground boundary inside the search window in the 2D space;
determine a correction offset in the 2D space between the ground boundary and a bottom of the projected 3D stixel the bottom of the projected 3D stixel corresponding to the bottom of the 3D stixel;
project the correction offset into the 3D space; and
train the machine learning model based on the projected correction offset.

11. A system for training a machine learning model, the system comprising:
one or more memories configured store the machine learning model; and
one or more processors communicatively coupled to the one or more memories, the one or more processors being configured to:
project a 3D stixel on a 2D image;
generate a search window based on a bottom of the 3D stixel in a 3D space;
project the search window in a 2D space, the 2D space corresponding with the 2D image;
determine a ground boundary inside the search window in the 2D space, based on one or more appearance features in the 2D image;
determine a correction offset in the 2D space between the ground boundary and a bottom of the projected 3D stixel, the bottom of the projected 3D stixel corresponding to the bottom of the 3D stixel;
project the correction offset into the 3D space; and
train the machine learning model based on the projected correction offset.

12. The system of claim 11, wherein a size of the search window is based on an average depth of the 3D stixel.

13. The system of claim 11, wherein the correction offset comprises a distance between a ground boundary and a bottom of the 3D stixel.

14. The system of claim 11, wherein the one or more appearance features comprise one or more edges of objects.

15. The system of claim 11, wherein the machine learning model comprises a cross-modal deformable stixel predictor.

16. The system of claim 15, wherein the machine learning model comprises a deformable kernel.

17. The system of claim 15, wherein the machine learning model comprises a deep neural network.

18. A method for controlling operation of a vehicle, the method comprising:
obtaining two-dimensional (2D) image data;
obtaining three-dimensional (3D) point cloud data;
generating one or more multimodal fused 3D stixels based on the 2D image data and the 3D point cloud data, wherein generating the one or more multimodal fused 3D stixels comprises executing a machine learning model, the machine learning model having been trained with a 3D stixel correction; and
controlling operation of a vehicle based on the one or more multimodal fused 3D stixels.

19. The method of claim 18, wherein controlling operation of the vehicle based on the one or more multimodal fused 3D stixels comprises:
determining a free space based on the one or more multimodal fused 3D stixels; and
controlling operation of the vehicle within the free space.

20. The method of claim 19, wherein controlling operation of the vehicle within the free space comprises controlling at least one of a steering of the vehicle, an acceleration of the vehicle, or a braking of the vehicle.
